(19) United States
(12) Patent Application Publication
(10) Pub. No.: US 2020/0016699 A1
(43) Pub. Date: Jan. 16, 2020

(54) PIPELINE TIE-IN APPARATUS AND METHODS

(71) Applicant: Gregg Richard Bruinsma, High River (CA)

(72) Inventor: Gregg Richard Bruinsma, High River (CA)

(21) Appl. No.: 16/206,282

(22) Filed: Nov. 30, 2018

Related U.S. Application Data
(60) Provisional application No. 62/697,724, filed on Jul. 13, 2018.

(51) Int. Cl. B23K 37/053

(52) U.S. Cl. CPC B23K 37/0533; B23K 2101/06

(57) ABSTRACT

A welding jig or gap tool and a method of operation is provided for welding management of the V-joint between facing pipe ends. One or more gap tools are distributed about the V-joint and actuated to maintain a welding gap along the V-joint during welding. The tool has a base portion removeably arranged between an alignment clamp and the pipe end. When actuated the gap tool bears against the alignment clamp and a cone is driven into the V-joint to establish and to maintain the gap between pipe ends.

### CROSS REFERENCE TO RELATED APPLICATIONS

This application claims the benefit of U.S. Application Ser. No. 62/697,724 filed 13 Jul. 2018, the entirely of which is incorporated fully herein by reference.

### FIELD

Embodiments herein relate to apparatus and methods for joining pipe ends, and more particularly to jigs and tools for aligning and welding facing pipeline ends in both automatic and manual welding operations.

### BACKGROUND

Pipeline construction from a plurality of pipe lengths comprises a combination of mainline and tie-in joint connections. Mainline connections are conducted outside the trench in easy to manage environment. Tie-ins are conducted, in the trench, at gaps between mainline connected joints as a result of landscape challenges including vehicle and water crossings or sudden changes in orientation.

Mainline joints are characterized by large internal alignment tools, readily employed at surface before lowering into a pipeline trench and recoverable at the end of the next joint. In contrast, tie-in joints are characterized by more manual techniques including the use of external alignment jigs or tools as access to the internal bore of the pipeline is difficult if not impossible.

Included in such alignment jigs are external pipe alignment clamps, or line clamps such as those available form KC Welding & Machine Crop, or DMI International, Inc. Such line clamps have three main functions: facing pipe end alignment, ovality and installation aid purposes.

For coaxial alignment of the pipe ends, a typical clamp has a pair of spaced annular rings, one ring for each pipe end. The spaced rings are supported structurally relative to one another for supporting both facing pipe ends at the same centers for alignment. The spaced rings provide access therebetween to the joint between the pipe ends for welding, that access being periodically interrupted with structural members extending between the spaced rings. Each ring has a significant stiffness for maintaining each pipe end as circular. The periphery of the inner diameter of each ring has circumferentially-spaced pads thereabout for point engagement of the pipe end for urging an oval pipe end into circular compliance. Rendering an oval pipe end into a circle, using hi/lo pins, reliably ensures alignment with the juxtaposed and opposing circular pipe end.

The clamp's annular rings are discontinuous or sectioned, typically as two half-circles, hinged one end for ease of installation about one pipe section prior to or even after the pipe ends are generally aligned. A diameter constricting clamping end draws the two half-circles together once in axial position about the pipe end. The circumferential clamping mechanism drawing one sectioned annular rings circumferentially together with the other for gripping and securing the pipe ends in axial alignment.

Once aligned the pipe ends are welded. In pipelines for the transport of hydrocarbons, the fit-up and welding are subject to strict procedures and electronic testing. Strict procedures are required for shielded electrodes having cellulose coatings and which introducing risk of hydrogen cracking. As a result, over the years the known shielded metal arc welding, is being supplanted with automatic Gas Metal Arc Welding (GMAW) or commonly known as metal-inert-gas (MIG) welding.

Automated MIG welding uses an inert gas instead of a cellulose coating which resolves the hydrogen cracking issues, but also introduces other changes requiring adaptation including butt weld gap shape and tolerances and the robot or tractors are known for a lack of flexibility in the event of a need to a change in the weld.

The pipe ends are prepared for butt welding by dressing or cleaning up the torch-cut pipe ends and ensuring the pipe ends are trued-up or otherwise made parallel with to the opposing end. The pipe ends are beveled, aligned end-to-end and welded. MIG typically uses a complete single-V joint without a land.

Often the pipe ends for one reason or another are not factory square, such as when cut in the field to fit. Such ends are often initially flame cut using a cutting torch and which results in the application of significant time to clean up the butt ends before welding together. Grinders are typically used to grind off high spots, slag or other imperfections. This work is manual and can result in variable welding gaps and misalignment.

In Applicant's co-pending application Ser. No. 15/799,373 filed Oct. 31, 2017 and which published on Aug. 30, 2018 as US 2018/0243832 A1, the entirely of which is incorporated fully herein by reference, a truing apparatus is provided comprising centering structure supported in the pipe ends by centralizing standoffs. The standoffs extend radially and are operable between a retracted position and an expanded position for locating the structure concentric within the pipe along the pipe axis. A truing tool is supported on a sleeve rotatable on the centralized support structure. The truing tool is rotated about the pipe end for 360 degree removal of high spots along the welding profile. Applicant's truing tool provides a more consistent surface for alignment of pipe ends for welding than manual methods.

Another factor affecting the quality of the joint is consistency of the width of the gap. During welding of a root pass along the joint, the cooling of the bead attempts draws the welding gap together ahead of the completed bead. A narrowed gap results in and off-spec joint.

Off-specification joints, identified through visual, ultrasonic or other non-destructive testing can require repair. A repair can require complete removal of the welded joint

What is still required in the art are tools and methods to assist in generating an acceptable joint at the first instance and avoiding repairs.

### SUMMARY

Herein a welding jig or gap tool is provided for welding management of the V-joint between facing pipe ends. One or more gap tools are distributed about the V-joint and actuated to maintain a welding gap along the V-joint during welding. The tool is removeably arranged between a stop associated with the pipe and the pipe ends. When actuated the tool bears against the stop and a cone is driven into the V-joint to establish and to maintain the gap between pipe ends. In one embodiment the stop for the tool is provided by an alignment clamp having annular rings extending about the pipe ends, the rings forming an annular space therebetween.

In one broad aspect, the gap tool itself comprises a body having base, the base having a left extension and a right extension, the base having a length adapted for engaging the alignment clamp. A linear actuator is actuable relative to the base and has a driving end with a cone at the driving end. When the actuator is actuated, the cone is forcibly driven radially into the V-joint for establishing a welding gap between the facing pipe ends, reactive loads at the actuator being transmitted into the body and the left and right extensions of the base bearing against the alignment clamp.

In another aspect, a system is provided for management of a welding gap at pipe ends including the combination of the alignment clamp and one or more gap tools. In this embodiment, the alignment tool can have spaced rings, each of which forms an annular space between the ring and its respective pipe end; and accordingly for each gap tool, the tool's base extends into the annular space for each ring so as to straddle the V-joint and the spaced rings.

In a broad embodiment of a methodology for utilizing an embodiment of the gap tool, a method is provided for welding the V-joint between the facing pair of tubular pipe ends by first arranging an alignment clamp about the pair of pipe ends for straddling the V-joint, clamping the alignment clamp thereabout for coaxial alignment thereof. The method continues by arranging at least a first gap tool between the alignment clamp and the pipe end and, for each gap tool arranged circumferentially along the V-joint, actuating the gap tool to forcibly drive the pipe ends apart to form a welding gap therebetween. The reactive loads imposed on the gap tool by the actuation thereof by engagement of the gap tool are supported against the alignment clamp.

### BRIEF DESCRIPTION OF THE DRAWINGS

FIG. 1A is a cross-sectional view of a trench and a simple end view of bulldozer and side boom supporting a portion of a pipeline in the trench;

FIG. 1B is a cross-sectional view of the trench of FIG. 1A, illustrating facing pipe ends of two strings of pipeline, each supported by respective side booms;

FIG. 2A is a view of misaligned and opposing pipe ends according to FIG. 1B;

FIG. 2B is a view of the opposing pipe ends aligned using a form of alignment clamp;

FIG. 3 is a side view of pipe ends in a prior art method illustrating a joint gap narrowing due to weld shrinkage during cooling, conventional wedges being inadequate to maintain the gap and subject to self-releasing;

FIG. 4 is a side view of pipe ends in a prior art method illustrating conventional wedges being inserted about the joint;

FIG. 5A illustrates partial side view of an upper portion of the joint at opposing pipe ends, the joint gap being maintained using a cone or gap tool according to one embodiment, one tool shown from the side and one tool from a top view, the cone of the gap tool configured for a 30 degree single V bevel angle (a 60 degree total included groove angle);

FIG. 5B illustrates a cross section of the top gap tool of FIG. 5A, shown from the side and in relation to the pipe ends and spaced rings of the pipe end alignment clamp;

FIG. 6 is a partial end view taken along the gap to view the gap tool against one face of the butt joint, and the relationship of the tool and the respective alignment ring of the pipe end alignment clamp;

FIGS. 7A and 7B illustrate installation of a gap gap tool between spaced rings of the pipe end alignment clamp for maintaining a consistent gap;

FIGS. 8A and 8B illustrate a top view and a side cross-sectional view respectively of an alternate gap tool;

FIG. 9A is a partial side view of a chord of a pipe and the alignment clamp at a clamping interface;

FIG. 9b is an end view of the clamping interface of FIG. 9A to illustrate a typical square drive head for the clamping bolt;

FIG. 10 is a top view of a gap tool having a typical square drive head for a threaded actuator, the drive head compatible with the clamping bolt;

FIG. 11 is a an end view of a pipe end having a pair of automated MIG welding machines arranged for welding the joint according to one embodiment of the methodology;

FIG. 12A is a side view of a top portion of the pipe ends illustrating one MIG machine tracking a guide band for welding a root pass of the joint;

FIG. 12B is a plan view of the MIG machine of FIG. 10A tracking the guide band for welding a root pass of the joint;

FIG. 13 is an end view of a pipe end illustrating conversion from automatic MIG welding to hand welding; and

FIG. 14 is front perspective view of another embodiment of a gap tool having a square drive head for a threaded actuator.

### DETAILED DESCRIPTION OF THE EMBODIMENTS

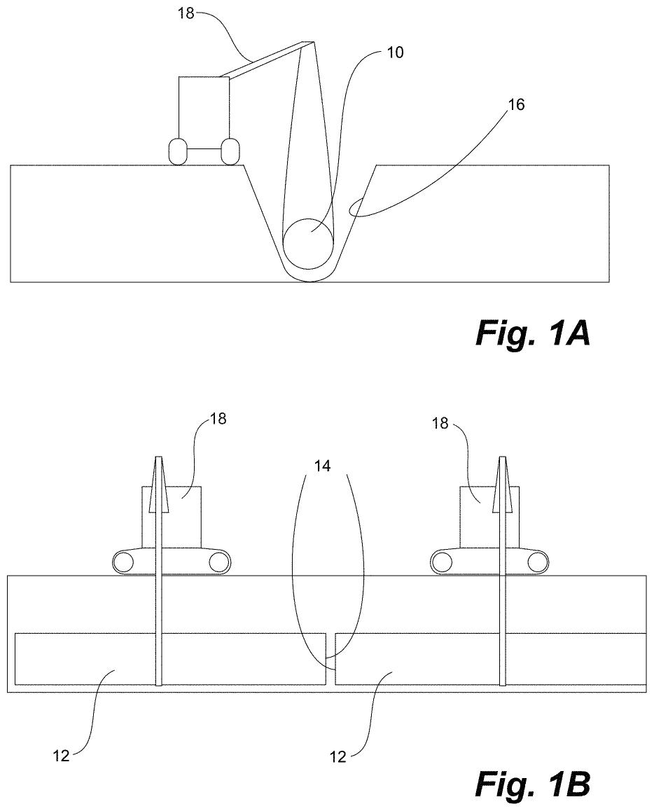

With reference to FIGS. 1A and 1B, pipelines 10 are assembled using lengths of tubular pipe 12,12, welded together at tubular pipe ends 14,14.

While long lengths of mainline joints between pipe ends 14 are readily assembled at surface, the final connections between mainline sections are made at tie-in joints. With mainline sections that can be very long, in the order of tens of kilometers in length, internal access is difficult if not prohibitive.

In FIG. 1A, the pipe lengths are supported in a trench 16. In FIG. 1B, the pipe ends 14,14 of two lengths of pipe 12,12 are generally aligned coaxially, suspended by respective boom equipment or booms 18. It is common to have up to eight side booms 18, 18 . . . in use to align the pipe ends 14,14.

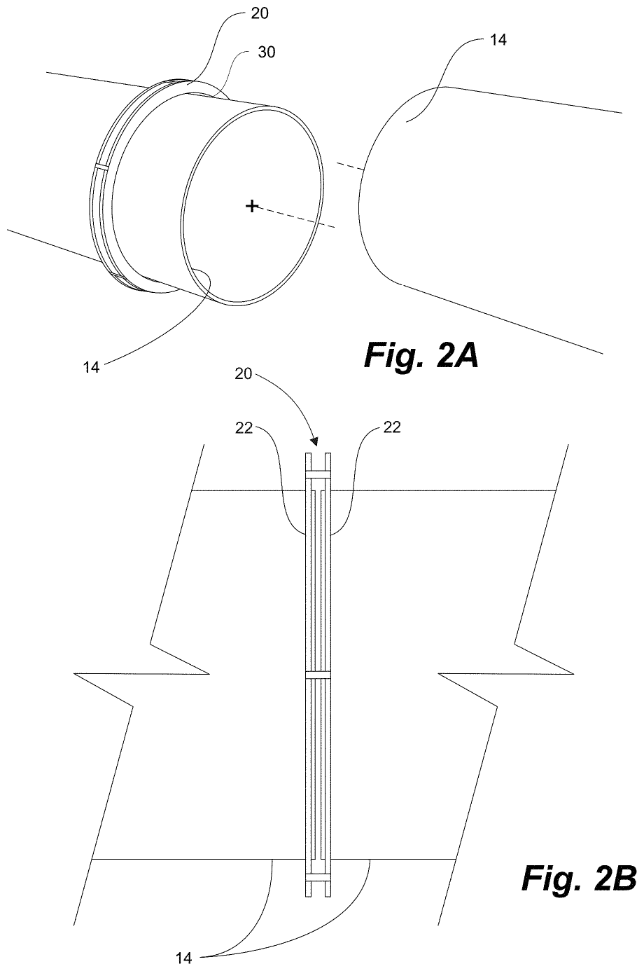

As shown in FIG. 2A, a facing pair of tubular pipe ends 14,14 are typically misaligned and must be coaxially aligned before welding. Tie-in joints are joined in the trench 16 including the use of external alignment clamps 20. The clamps 20 aid to align the pipe ends 12,12 coaxially for subsequent joining by welding.

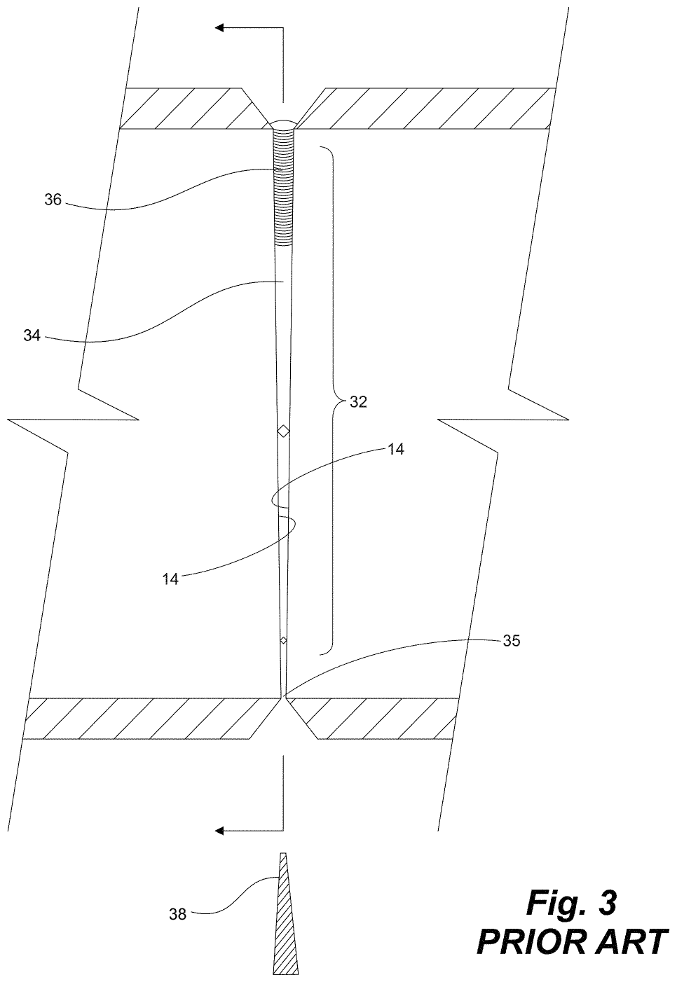

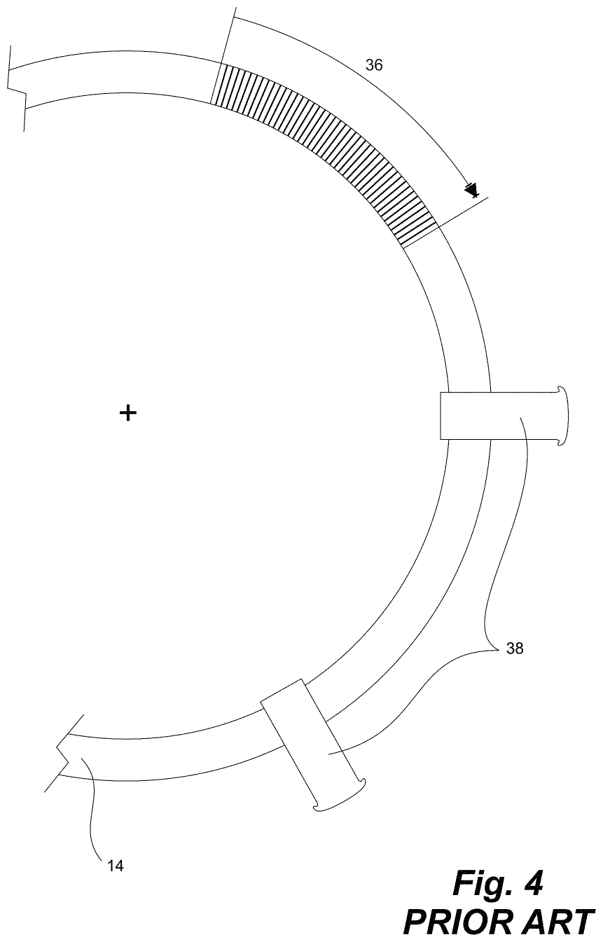

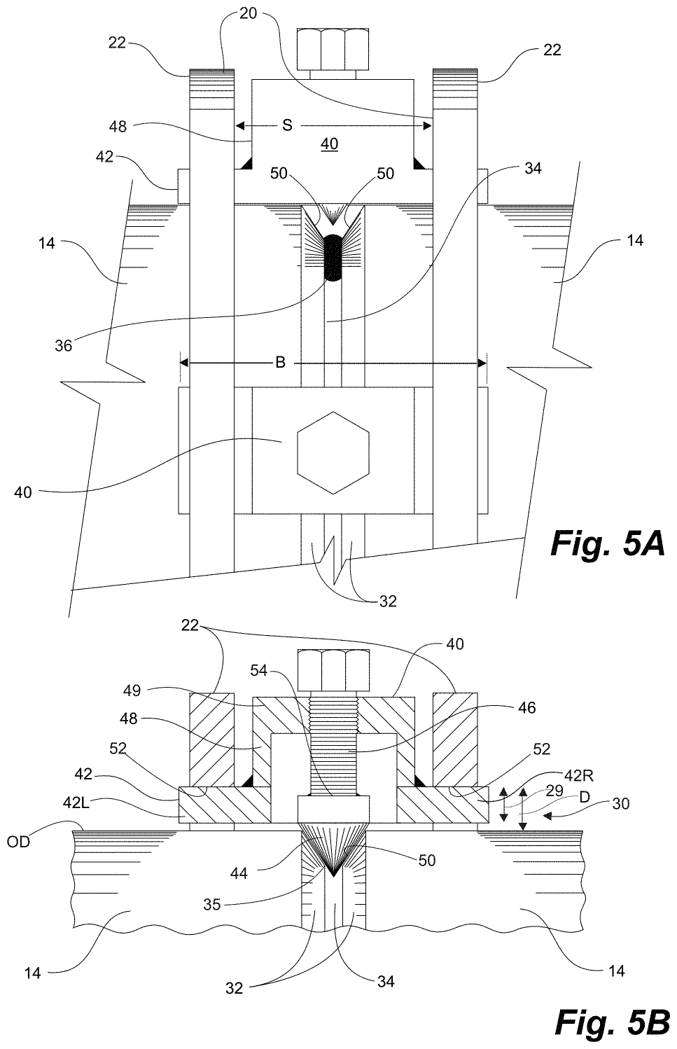

Prior to alignment, while accessible, each pipe end 14 is dressed and trued up to form a consistent welding joint with an opposing pipe end 14 as shown in FIGS. 3 and 5A.

In FIG. 2B, the pipeline alignment clamp 20 is of an expandable nature or clamshell arrangement. When expanded, the clamp 20 can be temporarily staged on one pipe 12, and can be shifted axially to straddle generally facing and opposing pipe ends 14,14 after rough alignment, actuation of the clamp 20 further aligning the axes or centers of the two pipes 12,12. Alternatively, the alignment clamp 20 can be opened fully to a diameter greater than that of the pipe 12 and installed after general alignment pipe ends 14,14.

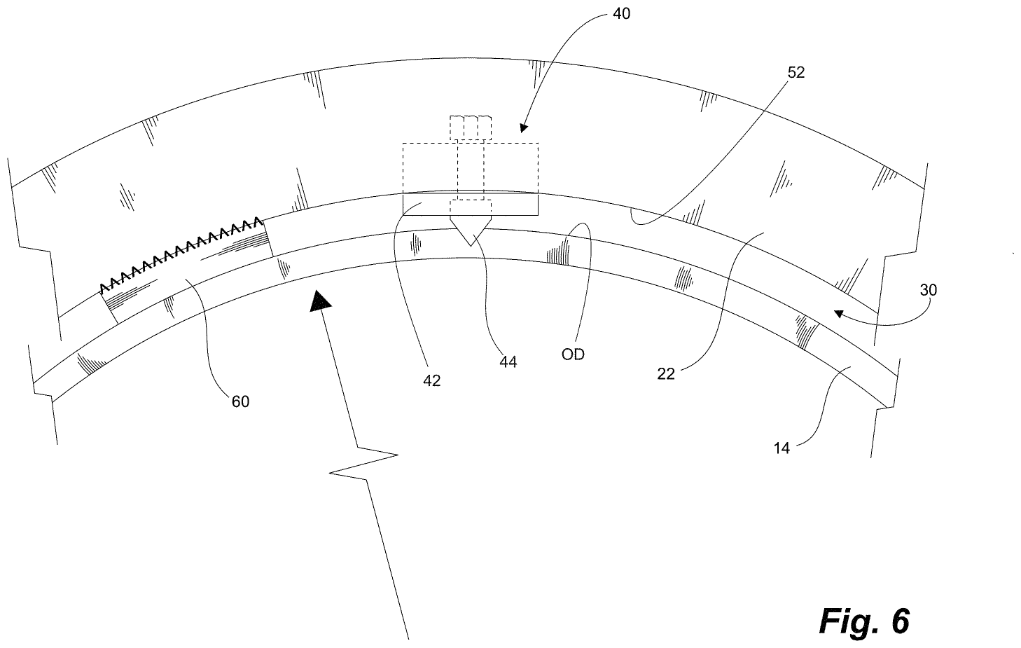

The alignment clamp 20 has two parallel and annular rings, structurally spaced axially so as to arrange one ring 22 about each pipe end 14. The rings 22,22 are structurally connected to form a single structure relatively across the pipe 12,12 so as to force co-axial alignment and circular compliance of their respective pipe ends 14,14. The rings 22 have an inner diameter ID greater than that of the pipe end forming an annular space 30 therebetween, as shown in FIG. 6. Ovality of a pipe end 14 can corrected to circular such as with the use of HI/LO pins or hammer wedges forcibly inserted in the annular space 30 to drive an eccentric portion of the pipe end 14 inward to a more circular form.

The alignment clamp rings 22,22 are spaced by distance S, typically suitable for access to the joint by the welding apparatus, both manual and automatic.

With reference to FIG. 3 and to illustrate a problem with the prior art, when welding long seams or joints 32, contraction of the metal bead 36, deposited at the joint 32, causes the leading edges of a joint welding gap 34 between pipe ends 14,14 being welded to draw together, adversely affecting the intended or design welding gap 34 and thus adversely affecting weld quality. In conventional tie-in welding, the contracting action is offset by wedging the joint edges apart ahead of the weld bead. For pipelines, conventional metal wedges 38 are typically inserted in the joint 32 as shown in FIG. 4, or inserted and then moved ahead as the weld progresses.

However, single-V bevel butt joints or V-joints 32, typical for MIG welding, are characterized by having no land. Instead, the root edge 34 of the joint has a sharp and structurally weak root area which is less competent for forcible separation by wedges 38. Coupled with thermal variation during welding and handling, can permit the wedges 38 to fall out.

With reference now to FIGS. 5A and 5B, and in one embodiment, a welding jig or gap tool 40 is provided for reliable management of the gap 34 at the joint 32. In the case of V or bevel butt welds, such as the single-V butt weld, the pipe ends 14,14 are prepared, each having a like bevel angle, typically 30 degrees. This forms a “V” gap 34 having an included V-groove angle between facing walls 50,50 of the pipe ends 14,14 of 60 degrees. The root 35 of the gap 34 may or may not have a root face thickness or land greater than zero. Stick electrode welding typically has a land, while butt joints for automatic MIG welding typically have no land, having a sharp edge at the root 35. When welding, a root pass bead 36 is first completed, then, multiple fill passes are laid down to a cap bead.

For effective gap management, the gap tool 40 is provided for V-type butt joints. As shown in FIGS. 5A through 8B, one or more gap tools 40,40 . . . can be employed about the pipe circumference in combination with a radial tool holddown structure, such as the annular rings 22,22 of an alignment clamp 20.

At least a first gap tool 40 is arranged between the alignment clamp and the pipe end and for each gap tool arranged circumferentially along the V-joint 32, the gap tool is actuated to forcibly drive the pipe ends 14,14 apart to form the welding gap 34 therebetween and reactive loads imposed on the gap tool 40 by the actuation thereof are supported by engagement of the gap tool against the alignment clamp 20.

The gap tool 40 has a base 42, a joint spacing cone 44 and a linear actuator 46 for radial adjustment of the cone 44. The actuator is supported in a tool housing or body 48. The actuator 46 drives the spacing cone 44 into the butt joint relative to the body 48. The cone 44 applies an axial spacing force to the V-groove of the butt joint, resisting contraction forces that close the gap 34 and avoiding damage to the root area 35.

The body 48 can comprise a planer form of base 42, such a rectangular plate, however, as shown, for accommodating a range of motion of the linear actuator 46, the body can further comprises a housing for spacing a offset driving plate 49 from the base 42. When the actuator is actuated to a retracted position, as shown in FIG. 5A, the cone is retracted to recess substantially inside a recess within the body 48. Accordingly, the gap tool is more easily manipulated into the annular space 30. As shown in FIG. 5B, when actuator 46 is actuated to an extended position, the cone 44 is extended, the cone projects into the V-Joint and hinders manipulation of the tool 40 until retracted.

The gap tool 40 is quickly and easily installed and removable for placement, repositioning along the V-joint 32 ahead of the welding and for reusability.

The gap tool 40 is a form of jacking device. The actuator 46 drives the cone 44 of the gap tool into the V-joint 32 for spacing of the gap 34 whilst reactive forces on the actuator 46 are directed into the body 48 having the base 42 which bears against an abutment or stop 52. The stop 52 accepts the reactive load imparted thereon by the body's base 42. The annular rings 22 of the alignment clamp 20 provide such a stop 52 available about the circumference of the pipe 12, however other forms of stops, such as individual localized stop (not shown) can be provided that are supported by the pipe 12. The illustrated annular stop 52 provides access all about the circumference of the pipe 12.

The actuator 46 is supported in the body 48 for linear actuation, the actuator movable radially towards and away from the point in operation. When actuated radially into the joint, the body 48 and base 42 are urged radially outward to engage the stop 52. Thus actuation of the cone 44 results in a cone movement radially into the V-joint 32 while the base 42 is held stationary against the reactive forces. In this embodiment, the actuator 46 comprises a linear driving member in threaded connection to the actuator body 48, in this instance to the driving plate 49. The threaded connection is a simple and robust connection that is easily repaired an inexpensive for ready replacement if damaged. A driving end 54 of the actuator 46 can be socket welded into the cone 44 for co-rotation therewith. The cone 44 can be manufactured of a 4130 alloy and heat treated for long operational life with the forces employed for gap management. The cone 44 could also be rotatable relative to the driving member 54, and therefore stationary relative to the V-joint 32 for reduced actuation torque requirements at added expense and complexity.

Other actuators, such as scissor jacking arrangements and hydraulic rams can be used however the economics are unfavorable given the larger spacing needed between the form of stop 52 provided and the pipe 12.

In the embodiment using an annular ring stop 52, conveniently provided in this embodiment by the alignment clamp 20, the pair of annular rings 22,22 straddle the V-joint 32. The annular rings 22,22 form the annular space 30 between the pipe 12 and the ring 22. The base 42 of the gap tool 40, has left and right base extensions 42L, 42R.

For the alignment clamp embodiments, a length B of the base 42, B including the extensions 42L, 42R is at least as long as that of the spacing S if the rings 22,22, the length B being adapted for engaging the alignment clamp 20. The extensions 42L,42R are tab-like members having a thickness 29 less than that of the depth D of the available annular space 30. The depth D of the annular space 30 is determined by the space between the respective rings 22 and the pipe end 14. The inner diameter of the annular rings 22,22 forms the tool-abutment stop 52. The extensions 42L,42R bear against the stop 52 in use. For a threaded actuator, the actuator body 48 can project upwards between the spaced rings 22,22. The projection and retraction of the actuator into the body 48 can be relatively sized to provide some range of adjustment for the actuator and enable installation. As shown in FIG. 5A, in an embodiment, the actuator 46 and correspondingly the cone 44 can be initially retracted into the body 48 to create a minimal profile for initial installation and placement.

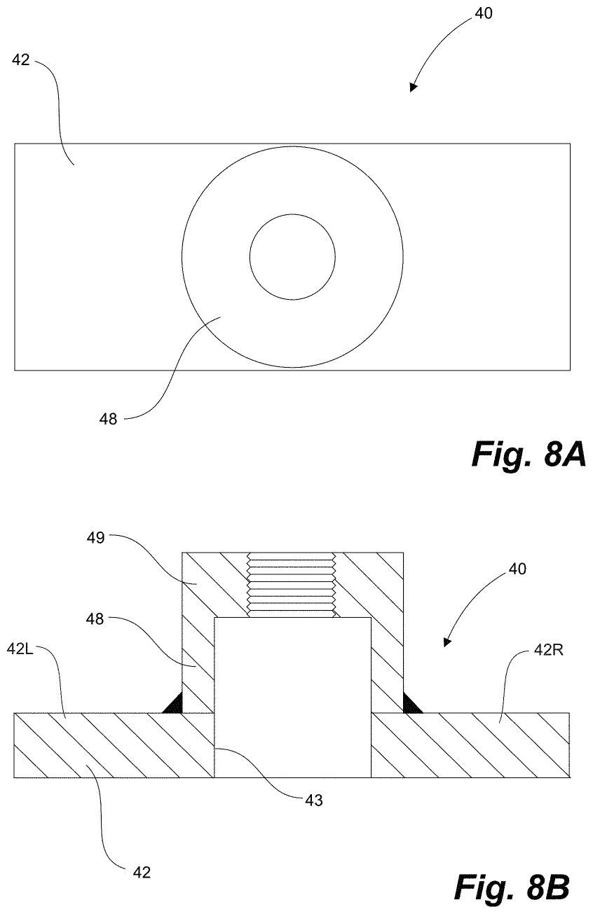

As shown in of FIGS. 5A and 5B, the body 48 can be manufactured with a hollow rectangular structure steel piece or of flat plate assembled piece work to support the offset driving plate 49 and create a recess for housing the cone 44 when retracted. Alternatively in FIGS. 8A and 8B, the body 48 can comprise a circular tubular pipe portion, upstanding perpendicular from the base 42. The base 43 has a port 43 (See FIG. 8B) through which the cone 44 can pass during retraction and extension.

In FIGS. 5B and 6, when the actuator 46 is extended, the cone 44 projects radially into the plane of the outer diameter of the pipe and into the joint. The length of the base 42 with left and right extensions 42L,42R is longer than the spacing between rings 22,22. A width of the base 42 is narrower that the spacing S of the rings 22,22 for ease of insertion therebetween before rotation of the base 42 to engage the stops 52,52.

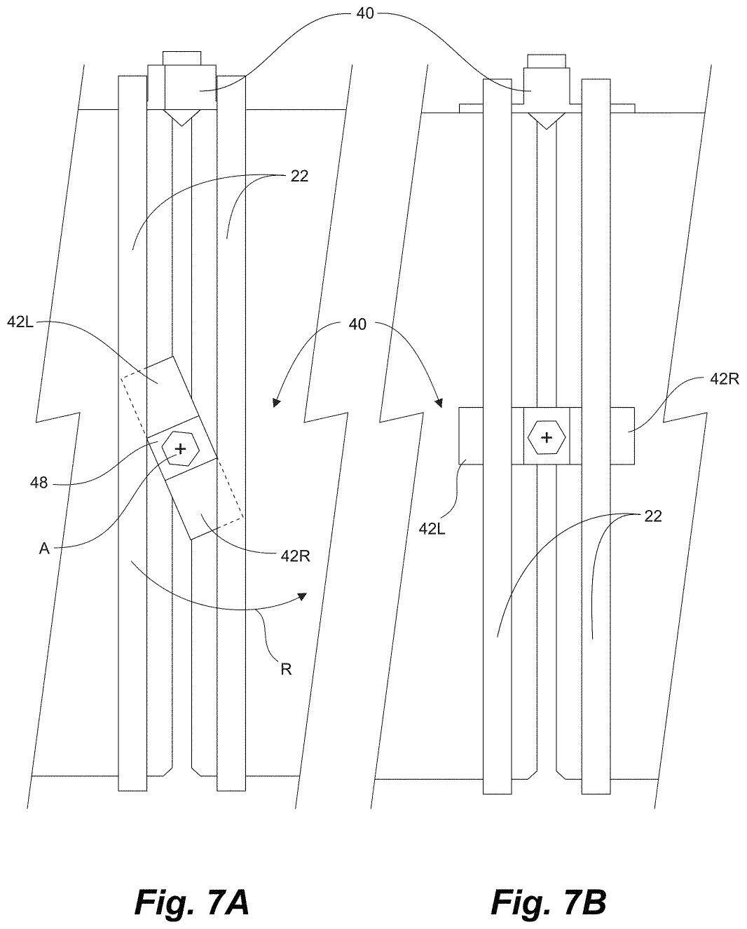

Accordingly, as shown in FIG. 7A, for initial installation, the gap tool 40 can be rotated to orient the base 42 generally aligned with the V-joint being about 90 degrees from its normal operational alignment so as to fit between the clamped and spaced rings 22,22 and enable insertion of the tool 40. The body 48 is sized to fit between the spaced rings 22,22 in the rotated and operational alignment. Once inserted, the gap tool's left and right base extensions are rotated to align generally axially so as to be supported between the rings 22,22 and the respective pipe ends 14,14.

The tool base 42 is rotated generally about the actuator axis. In FIG. 7A, a partial rotation of the tool 40 is shown with the extensions 42L,42R starting to project into the annular space 30 between the rings and pipe ends. In FIG. 7B, the extensions 42L,42R are fully under the rings 22, projecting through the annular space 30. When actuated, the cone 44 engages the V-joint 32, and the extensions are reactively forced outward to engage the underside, stop portion of the rings.

Returning to FIG. 6, the extensions 42L,42R are shown in solid lines in the annular space 30 under the rings 22. Also shown is one form of spacer foot 60 associated with the alignment ring 22 which applies point loads to the pipe ends for ovality correction and for maintaining the annular space 30 for ease of insertion of a gap tool 40.

In FIG. 7B, the gap tool 40 can be moved circumferentially along the V-joint 32 as required. A plurality of gap tools 40,40 . . . can be distributed circumferentially about the pipe end 14 before starting the welding process, and gap tools 40 installed ahead of the bead 36 can be advanced forward along the V-joint 32, or removed entirely, as the welding process approaches each gap tool 40.

Returning to FIG. 5B, when a gap tool 40 is engaged to bear against its stop 52 or stops 52,52, the cone 44 can be actuated to the extended position to forcibly drive the cone 44 into the V-joint 32 for establishing the welding gap 34 between the facing pipe ends 14,14.

The gap tool actuator 46 is driven radially towards the V-joint 32. The cone 44 has a cone angle that is generally matched to the joint groove angle. For example for a joint having a total included groove angle of 60°, the total angle of the cone 44 would also be a corresponding 60°. As the actuator drives the cone 44 into the V-joint 32, the conical side walls of the cone 44 engage the facing “V” walls 50,50 of the bevel V-joint 32. Due to the groove angle, an axial force component is generated as radial force is imparted to the cone 44. Thus the axial force forces the pipe ends 14,14 apart for forming the design gap 34, and maintaining once the joint gap 34 is already set.

The force on the bevel V-joint 32 imparted by the cone 44 is distributed along the facing walls 50,50 of the bevel V-joint 32 and does not damage the root area 35, and further the cone and gap tool 40 are strong enough to manage pipe handling forces and bead contraction forces during cooling, for maintenance of a consistent gap 34 for optimal MIG welding performance. The gap 34 for automated MIG welding is in the order of about 1.3 mm. The typical sharp edge of the root 35 is vulnerable to damage and use of the gap tool 40 mitigates aggravating damage and joint gap variability.

The walls 50 of a typical embodiment of a single-V bevel butt joint each have a 30 degree bevel for a total included groove angle between pipe ends 14,14 of 60 degrees and the gap tool 40 has a corresponding 60 degree cone angle. The root pass is generally the most difficult and most critical, setting the penetration and a continuous bead 36 without blowing holes through the root 35, and forms the source of most inspection failures. The gap tool 40 reduces such failures. V-joints can have single bevel angles of 5 degrees to 45 degrees for corresponding total include angles of 10 degrees to 90 degrees. In other words, for pipe ends each having a 45° bevel, a corresponding cone 44 has a total including angle of 90° for engaging the 45° bevel of a left pipe end 14 and 45° bevel of a facing right pipe end 14.

The gap tool is removeably arranged to engage the pipe ends and alignment clamp rings. To release or remove a gap tool 40, the cone 44 can be actuated to the retracted position to retract the cone 44 from the V-joint 32 and partially or wholly within the body 48 for ease for removal from the annular space 30 and from between the rings 22,22.

The actuation of the actuator 46 for the gap tool 40 can be conveniently matched to the operating hardware for the alignment clamp 20.

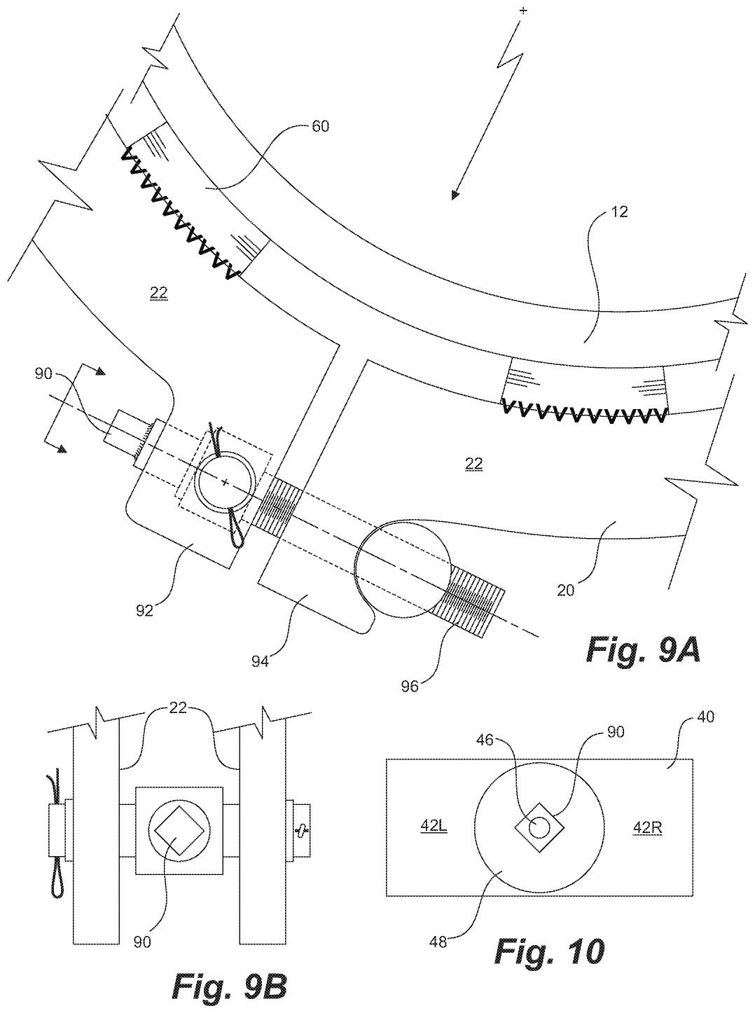

With reference to FIGS. 9A and 9B, some alignment clamps 20 use square drive heads 90 for adjustment using a socket or wrench. A clamping interface for such an alignment tool 20 comprises discontinuous rings 22,22 having first and second ends 92,94 bridged by an adjustable bolt and toggle arrangement 96. The bolt has a square drive head 90.

Accordingly, the variety of tools required for on-site personnel is reduced. Both the alignment clamp 20 and each gap tool 40 can be actuated with the same drive tool or wrench. A drive head of the gap tool actuator 46 can be matched to the majority of the style of alignment clamps 20 chosen for a project. In FIGS. 5B to 7B, the drive head is illustrated as a common hexagonal bolt head. However, it is also known for alignment clamps 20 to utilize square drive heads.

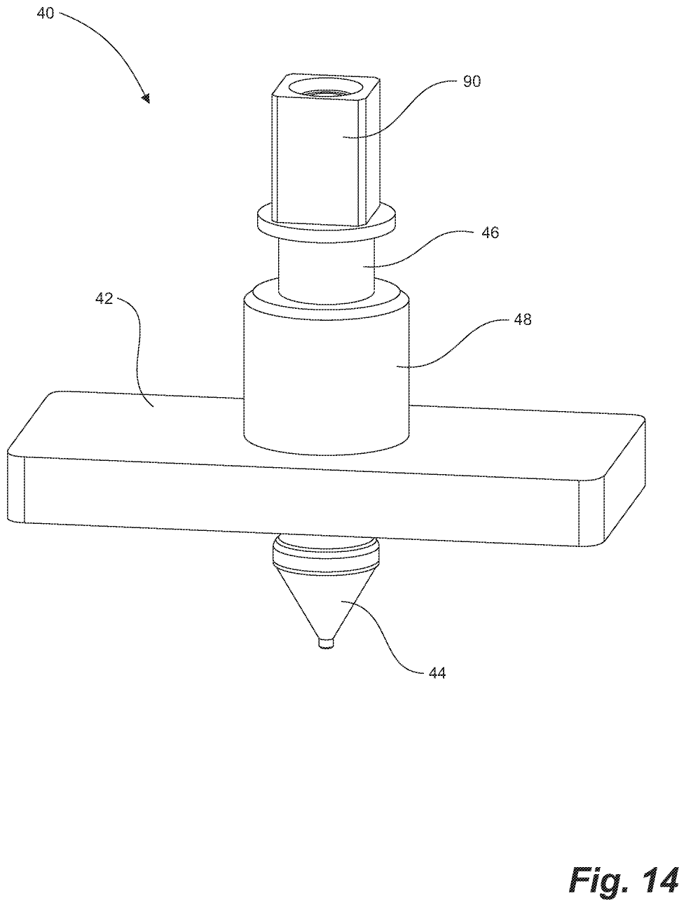

Thus, as shown in FIG. 10 and in an embodiment shown in FIG. 14, a convenient form of gap tool 40 also includes an actuator 46 having a square drive head 90, for operation or actuation of both of the alignment clamps 20 and the gap tools 40 using the same socket or wrench.

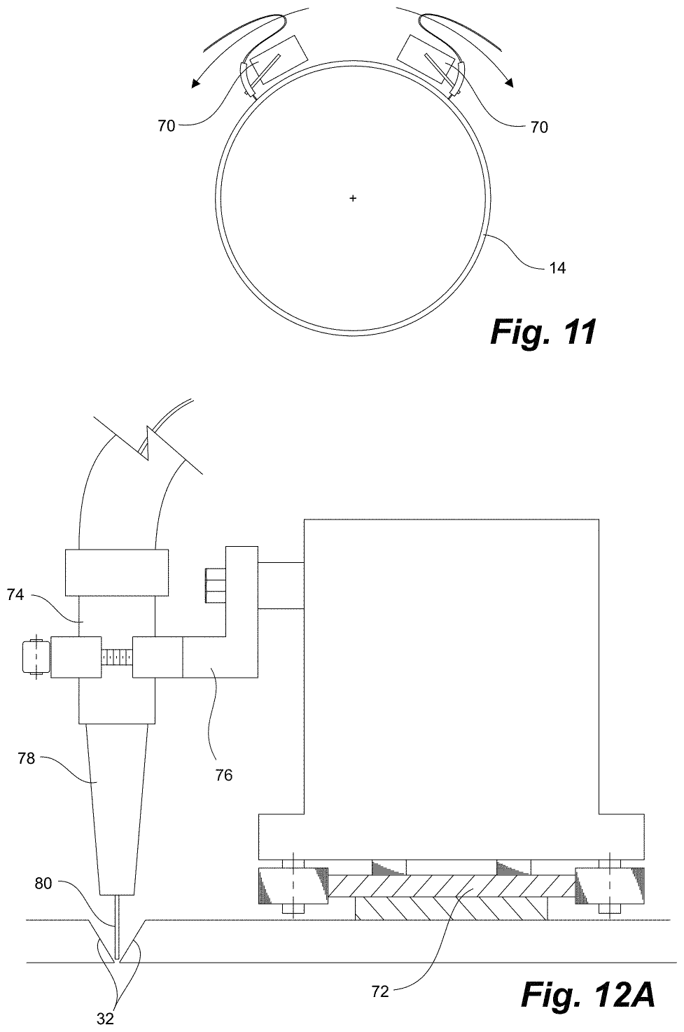

As shown in FIG. 11, for welding a single-V butt joint about opposing pipe ends 14,14, especially for pipelines having diameters in the rage of 20″ to 36″, two automated MIG welding machines 70,70 or “bugs” can be employed, both of which start at the top of the pipe 12, one travelling down clockwise and one travelling down counterclockwise. The MIG machines 70 are guided by a guide band 72 clamped to the pipe 121. Often 50% of the root pass bead 36 must be completed before the alignment clamp 20 can be removed. Accordingly, during welding of the root pass, there can be many forms of obstructions along including periodic annular ring spacers 60, clamping apparatus, and tools for the gap management. The gap tool 40 minimizes damage and is easily moved before it becomes an obstruction. The gap tool 40 also enables a larger portion of the root pass to be to be completed, about 60% in some cases, before there is a need to remove the alignment clamp 20.

As stated, after about 50%, and now, after about 60% of the root pass bead 36 is completed, the alignment clamp 20 can be removed. The pipes 12,12 are self-supported by the weld bead 36. The rest of the root pass bead 36 can then be completed. Non-welding personnel, including boom operators and skilled labor, can be effectively retasked to the next V-joint 32 between the next lengths of h pipes 12,12. After the entire critical, and challenging, root bead is in, the butt V-joint 32 merely needs added fill weld material to complete the work and, further, less supervision is required as the MIG welding machine 70 is able to track the guide band 72 and complete its multiple fill passes with little risk of weld defects.

The prior art tie-in joint might have taken 2 to 3 hours for two welders. Now, in combination with quality pipe end preparation using Applicant's related truing apparatus and the efficient use of one or more gap tools 40 for gap management under automated and hand welding, the time taken per V-joint 32 can be as little as about 45 minutes.

Other than obstructions, the quality of automated MIG welding is also vulnerable to guide band 72 and V-joint 32 misalignment, including band damage, non-parallel setup or joint irregularities. Herein, conventional MIG machines 70 are also modified to compensate for most misalignments.

Misalignment and other joint and MIG welding irregularities, including inert gas outage or machine failure can result in defects in the weld 36. To avoid defects, discovered in later testing, in many cases the inflexibility of the automated welding can be handled with the use of occasional but important manual welding techniques.

The conventional automated MIG machine 70 apparatus, such as those from CRC-Evans or Dyna-Torque, both of Houston, Tex., can be enhanced.

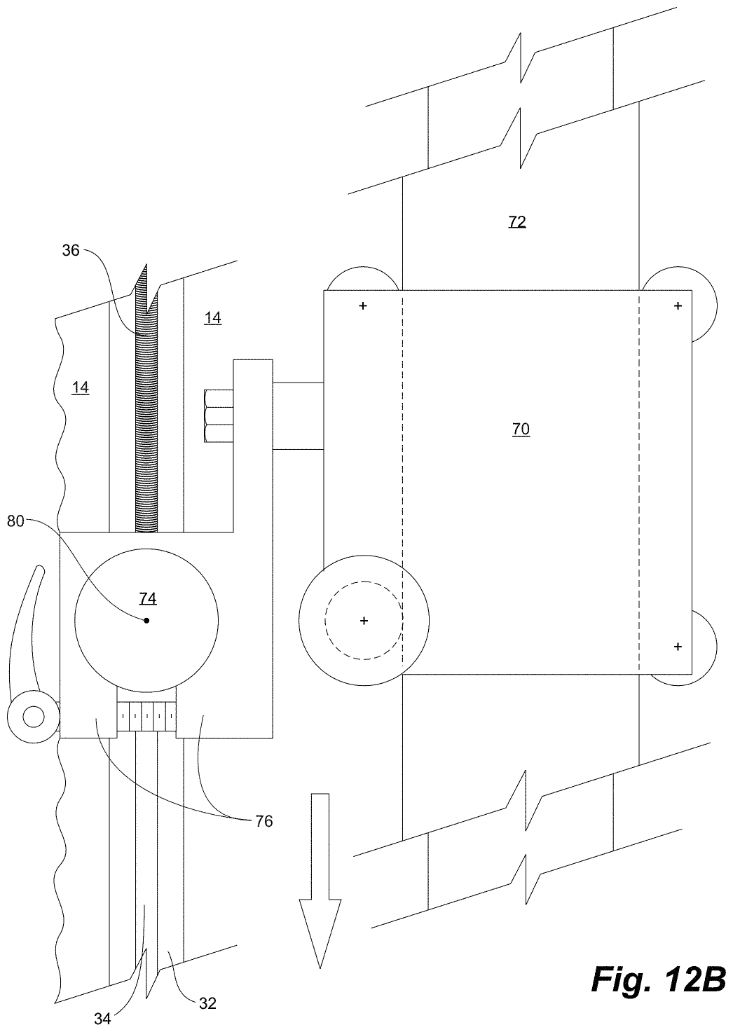

With reference to FIG. 12A, the MIG machine further comprises a MIG gun 74 and a replaceable tip 78 for dispensing wire 80. Herein, a gun clamp 76 is provided for precise removable and reinstallation of the MIG gun 74 for conversion between automated and hand welding operations. The gun clamp 74 can be provided with alignment or registration stops to ensure quick coupling and decoupling with repeatable positioning of the gun tip 78.

Further, the gun 74 can be manipulated in multiple degrees of freedom through programming and/or remote operation. Programming provides machine advance speed and gun tip weave controls. Added functions enables remote fine controls including adjusting gun placement relative to the V-joint 32 such as to handle misalignment that increase outside of specifications, or tip proximity or speed, without having to resort to re-programming the machine 80.

An operator can monitor the automatic welding and, on-the-fly, adjust the various aspects, including shifting the gun 74 or offset the tip from the nominal joint alignment, using a wireless remote during welding.

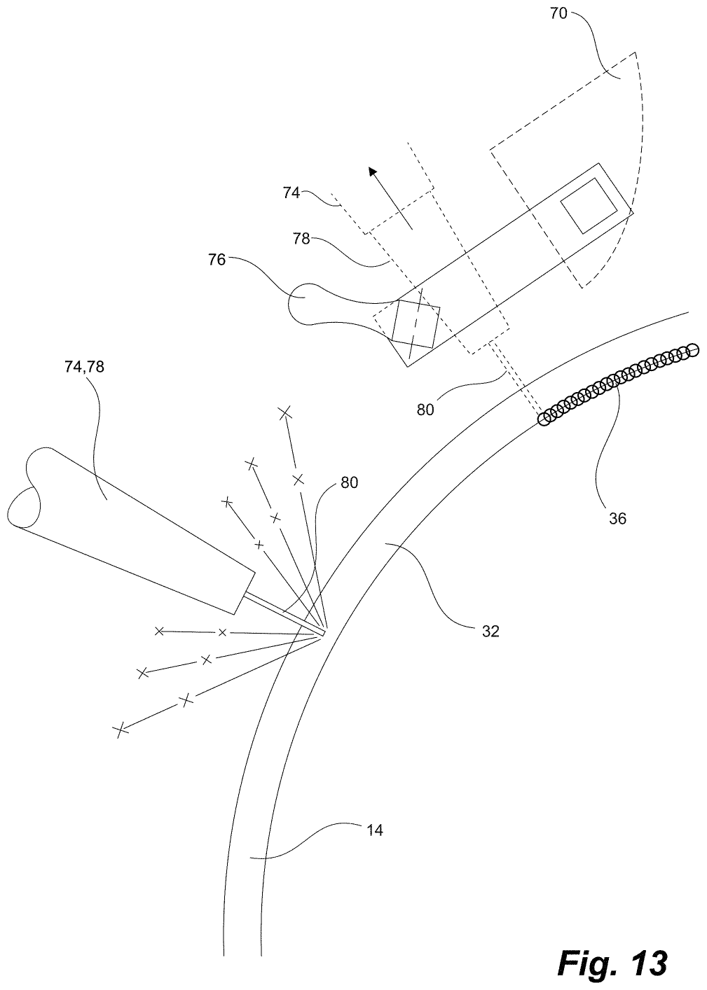

Further, and with reference to FIG. 13, hand work can be needed periodically to immediately and quickly handle a weld quality problem before subsequent fill passes obscure the defect. A shown, the gun clamp can be released from its automatic position (shown in dotted lines) so as to remove the gun 74 for such hand work. A bevel defect, a gap, a hole, or poor weld bead due to upset welding condition can be fixed immediately without significant downtime or resetting of the automated operations. Further, after the weld is substantially complete, undercut and other edges defects can be touched up by hand. Once the hand work is complete, the gun 74 can be returned to the gun clamp 76 for automated welding.

Through use of the gap tool, post inspection defects are substantially eliminated for significant savings in time and expenses.

We claim:

1. A gap tool for welding a V-joint between a facing pair of tubular pipe ends aligned coaxially with an alignment clamp straddling the V-joint, comprises:
a body having base, the base having a left base extension and a right base extension, the base having a length adapted for engaging the alignment clamp;
a linear actuator actuable relative to the base to at least an extended position, the actuator and having a driving end; and
a cone at the driving end,
wherein when the actuator is actuated to the extended position, the cone is forcibly driven radially into the V-joint for establishing a welding gap between the facing pipe ends, reactive loads at the actuator being transmitted from the left and right base extensions to the alignment clamp.

2. The gap tool of claim 1, wherein the cone and the V-joint have a total included angle of 10 degrees to 90 degrees.

3. The gap tool of claim 2, wherein the cone and the V-joint have a total included angle of 60 degrees.

4. The gap tool of claim 1, wherein the linear actuator is a threaded driving member in threaded connection to the actuator body.

5. The gap tool of claim 1, wherein the body further comprises a driving plate offset from the base for threaded connection to the actuator's driving member and forming a recess in the body into which the cone can be retracted.

6. A system for welding a V-joint between a facing pair of tubular pipe ends comprises:
an alignment clamp adapted for straddling the V-joint and coaxial alignment of the pair of pipe ends; and
a gap tool body having base, the base having a left extension and a right base extension, the base having a length adapted for engaging the alignment clamp, the gap tool further comprising:
a linear actuator actuable relative to the base and having a driving end; and
a cone at the driving end,
wherein when the cone is forcibly driven radially into the V-joint, a welding gap is established between the pipe ends, reactive loads at the actuator are transmitted into the body and the left and right base extensions bear against the alignment clamp.

7. The system of claim 6, wherein:
the alignment tool has spaced rings, each of which forms an annular space between the ring and its respective pipe end; and for each gap tool,
the base extends into the annular space for each ring so as to straddle the V-joint and the spaced rings.

8. The system of claim 6, wherein the cone and the V-joint have a total included angle of 10 degrees to 90 degrees.

9. The system of claim 8, wherein the cone and the V-joint have a total included angle of 60 degrees.

10. The system of claim 6, wherein the linear actuator is a threaded driving member in threaded connection to the actuator body.

11. The system of claim 6, wherein the body further comprises a driving plate offset from the base for threaded connection to the actuator's driving member and forming a recess in the body into which the cone can be retracted.

12. The system of claim 6, wherein the alignment clamp further comprises a pair of spaced rings, each ring forming an annular space between the rings and the pipe ends, the annular space having a depth, and the base has a thickness less than that of the depth of the annular space, wherein the left and right base extension extend axially to bear against the rings.

13. The system of claim 12, wherein the body is sized to fit between the pair of spaced rings.

14. A method for welding a V-joint between a facing pair of tubular pipe ends, the method comprising:
arranging an alignment clamp about the pair of pipe ends for straddling the V-joint;
clamping the alignment clamp about the pipe ends for coaxial alignment thereof; and
arranging at least a first gap tool between the alignment clamp and the pipe end and for each gap tool arranged circumferentially along the V-joint,
actuating the gap tool to forcibly drive the pipe ends apart to form a welding gap therebetween; and
supporting reactive loads imposed on the gap tool by the actuation thereof by engagement of the gap tool against the alignment clamp.

15. The method of claim 14, wherein the actuating of the gap tool comprises actuating a linear actuator to extend radially into the V-joint relative to a gap tool body wherein the body bears radially outwardly against the alignment clamp.

16. The method of claim 15, wherein the alignment tool has spaced rings each of which forms an annular space between the ring and its respective pipe end, and wherein the arranging of each gap tool between the alignment clamp and the pipe end, before actuating thereof, further comprises:
orienting the gap tool to fit between the clamp's spaced rings; and
rotating the gap tool so as to be supported between the rings and the pipe ends.

17. The method of claim 16, wherein the rotating of the gap tool to be supported between the rings and the pipe ends comprises rotating the body so that the left and right base extensions are supported between the rings and the respective pipe ends.

18. The method of claim 14, wherein the linear actuator is a threaded driving member in threaded connection to the actuator body.

19. The method of claim 14, further comprising removing the a least first gap tool by actuating the gap tool to release the gap tool from the pipe ends.
